(19) United States
(12) Patent Application Publication
(10) Pub. No.: US 2007/0298833 A1
(43) Pub. Date: Dec. 27, 2007

(54) Method and System for Frequency Conversion for Bluetooth and FM

(76) Inventors: Ahmadreza Rofougaran, Newport Coast, CA (US); Bojko Marholev, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/425,551

(22) Filed: Jun. 21, 2006

(51) Int. Cl. H04B 7/00; H04B 1/40

(52) U.S. Cl. 455/552.1; 455/41.2; 455/76

(57) ABSTRACT

Methods and systems frequency conversion for Bluetooth and FM radio are provided. FM data may be received and/or transmitted via the FM radio and Bluetooth data may be received and/or transmitted via the Bluetooth radio. With an integration of frequency conversion for Bluetooth and FM, both systems may operate from a single frequency source, thereby reducing part count and power consumption. Communication between Bluetooth and FM channels may be enabled via a single chip.

### CROSS-REFERENCE TO RELATED APPLICATIONS/INCORPORATION BY REFERENCE

The application makes reference to, claims priority to, and claims the benefit of U.S. Provisional Application Ser. No. 60/685,239 filed on May 26, 2005.

This application also makes reference to:
U.S. application Ser. No. 11/287,120 filed on Nov. 22, 2005;
U.S. application Ser. No. 11/286,950 filed on Nov. 22, 2005;
U.S. application Ser. No. 11/287,075 filed on Nov. 22, 2005;
U.S. application Ser. No. 11/287,181 filed on Nov. 22, 2005;
U.S. application Ser. No. 11/286,947 filed on Nov. 22, 2005;
U.S. application Ser. No. 11/287,034 filed on Nov. 22, 2005;
U.S. application Ser. No. 11/287,044 filed on Nov. 22, 2005;
U.S. application Ser. No. 11/286,844 filed on Nov. 22, 2005;
U.S. application Ser. No. ______ (Attorney Docket No. 17112US02) filed in even date herewith;
U.S. application Ser. No. ______ (Attorney Docket No. 17114US02) filed in even date herewith; and
U.S. application Ser. No. 11/176,417 filed on Jul. 7, 2005.

Each of the above stated applications is hereby incorporated herein by reference in its entirety.

### FIELD OF THE INVENTION

Certain embodiments of the invention relate to Bluetooth and FM communication technologies. More specifically, certain embodiments of the invention relate to a method and system for frequency conversion for Bluetooth and FM.

### BACKGROUND OF THE INVENTION

With the popularity of portable electronic devices and wireless devices that support audio applications, there is a growing need to provide a simple and complete solution for audio communications applications. For example, some users may utilize Bluetooth-enabled devices, such as headphones and/or speakers, to allow them to communicate audio data with their wireless handset while being free to perform other activities. Other users may have portable electronic devices that may enable them to play stored audio content and/or receive audio content via broadcast communication, for example.

However, integrating multiple audio communication technologies into a single device may be costly. Combining a plurality of different communication services into a portable electronic device or a wireless device may require separate processing hardware and/or separate processing software. Moreover, coordinating the reception and/or transmission of data to and/or from the portable electronic device or a wireless device may require significant processing overhead that may impose certain operation restrictions and/or design challenges. For example, a handheld device such as a cellphone that incorporates Bluetooth and Wireless LAN may pose certain coexistence problems caused by the close proximity of the Bluetooth and WLAN frequency converters.

Furthermore, simultaneous use of a plurality of radios in a handheld may result in significant increases in power consumption. Power being a precious commodity in most wireless mobile devices, combining devices such as a cellular radio, a Bluetooth radio and a WLAN radio requires careful design and implementation in order to minimize battery usage. Additional overhead such as sophisticated power monitoring and power management techniques are required in order to maximize battery life. Moreover, the use of multiple oscillators for Bluetooth and FM radio is expensive in terms of power consumption.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for method and system for frequency conversion for, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary single chip with integrated Bluetooth and FM radios that supports multiple interfaces, in accordance with an embodiment of the invention.

FIG. 1B is a block diagram of an exemplary FM transmitter that communicates with handheld devices that utilize a single chip with integrated Bluetooth and FM radios, in accordance with an embodiment of the invention.

FIG. 1C is a block diagram of an exemplary FM receiver that communicates with handheld devices that utilize a single chip with integrated Bluetooth and FM radios, in accordance with an embodiment of the invention.

FIG. 2 is a block diagram of an exemplary system that supports Bluetooth and FM radio communication in accordance with an embodiment of the invention.

FIG. 3 is a block diagram of another exemplary system that supports Bluetooth and FM radio communication in accordance with an embodiment of the invention.

FIG. 4 is a flow diagram that illustrates exemplary steps for frequency conversion in accordance with an embodiment of the invention.

FIG. 5 is a flow diagram that illustrates an exemplary method for frequency conversion in accordance with an embodiment of the invention.

### DETAILED DESCRIPTION OF THE INVENTION

Certain embodiments of the invention may be found in a method and system for frequency conversion for Bluetooth and FM. Certain embodiments of the invention may comprise a Bluetooth and an FM radio that are integrated on a single chip. The single chip Bluetooth and FM radio may provide a versatile platform that supports both Bluetooth and FM audio capabilities. For example, the single chip Bluetooth and FM radio may enable a user to have the capability to select from multiple audio-based services without the need to purchase and travel with a plurality of different devices. In one embodiment of the invention, FM data may be communicated via a first signal generated by a first programmable synthesizer, and Bluetooth data may be communicated via a second signal generated by a second programmable synthesizer. The first programmable synthesizer may be controlled via a frequency controller that is communicatively coupled to an FM processor that enables communication of the FM data. The second programmable synthesizer may also be controlled via the frequency controller that is communicatively coupled to a Bluetooth processor that enables communication of the Bluetooth data.

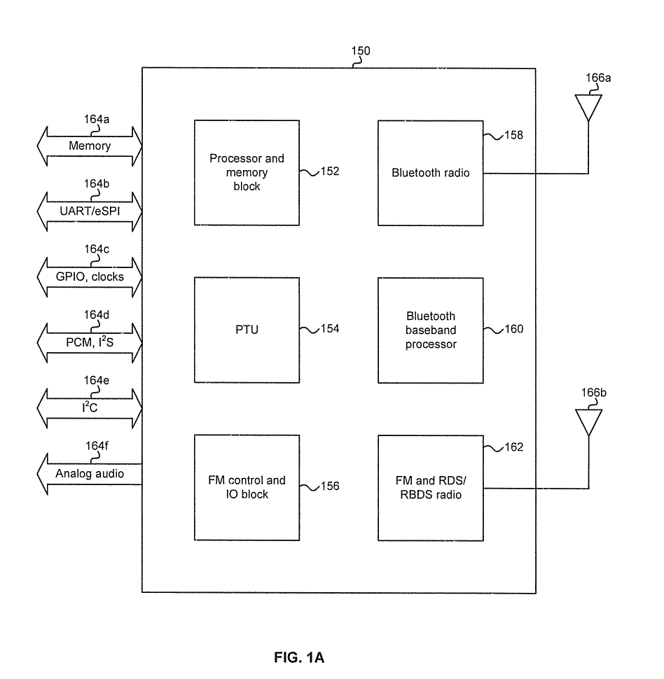

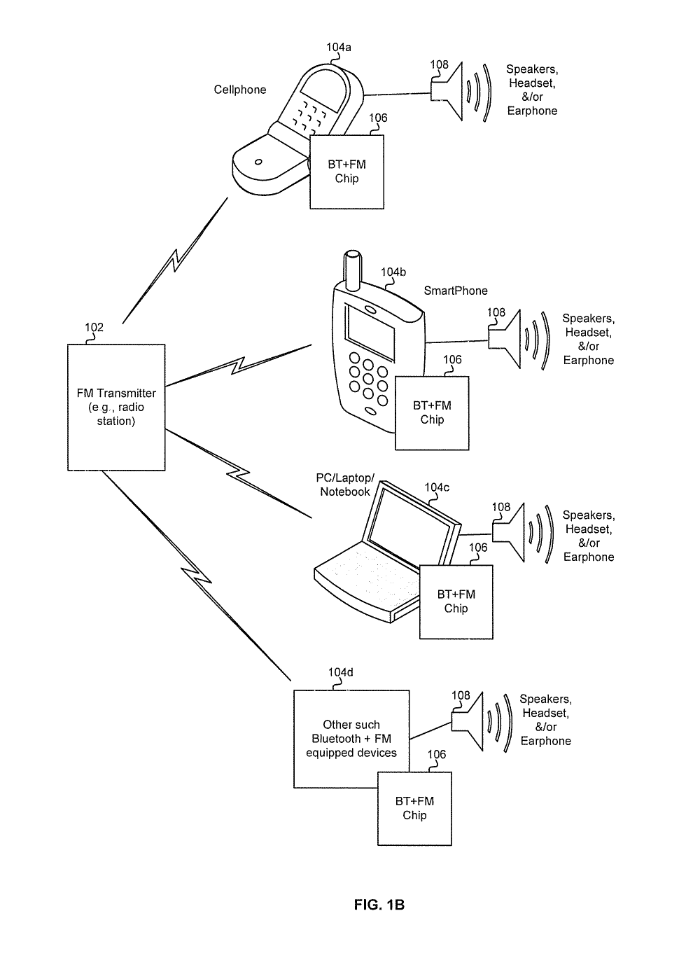

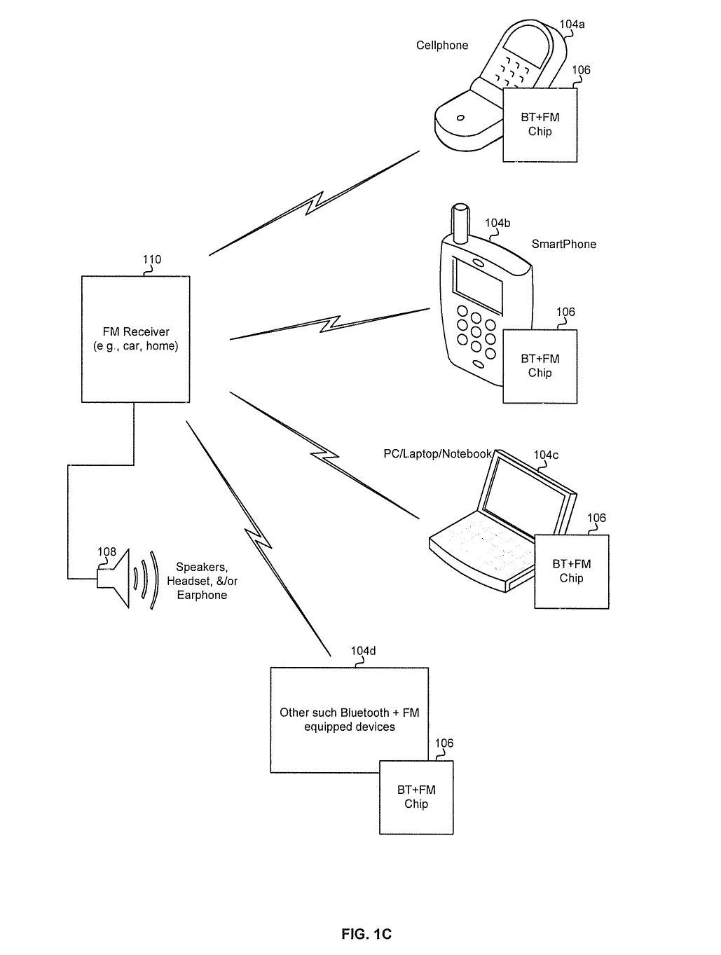

FIG. 1A is a block diagram of an exemplary single chip with integrated Bluetooth and FM radios that supports multiple interfaces, in accordance with an embodiment of the invention. Referring to FIG. 1A, there is shown a single chip 150 that supports Bluetooth and FM radio communications. The single chip 150 may comprise a processor and memory block 152, a PTU 154, an FM control and input-output (10) block 156, a Bluetooth radio 158, a Bluetooth baseband processor 160, and an FM and radio data system (RDS) and radio broadcast data system (RBDS) radio 162. A first antenna or antenna system 166a may be communicatively coupled to the Bluetooth radio 158. A second antenna or antenna system 166b may be communicatively coupled to the FM and RDS/RBDS radio 162.

The processor and memory block 152 may comprise suitable logic, circuitry, and/or code that may enable control, management, data processing operations, and/or data storage operations, for example. The PTU 154 may comprise suitable logic, circuitry, and/or code that may enable interfacing the single chip 150 with external devices. The FM control and 10 block 156 may comprise suitable logic, circuitry, and/or code that may enable control of at least a portion of the FM and RDS/RBDS radio 162. The Bluetooth radio 158 may comprise suitable logic, circuitry, and/or code that may enable Bluetooth communications via the first antenna 166a. The FM and RDS/RBDS radio 162 may comprise suitable logic, circuitry, and/or code that may enable FM, RDS, and/or RBDS data communication via the second antenna 166b. The Bluetooth baseband processor 160 may comprise suitable logic, circuitry, and/or code that may enable processing of baseband data received from the Bluetooth radio 158 or baseband data to be transmitted by the Bluetooth radio 158.

The PTU 154 may support a plurality of interfaces. For example, the PTU 154 may support an external memory interface 164a, a universal asynchronous receiver transmitter (UART) and/or enhanced serial peripheral interface (eSPI) interface 164b, a general purpose input/output (GPIO) and/or clock interface 164c, a pulse-code modulation (PCM) and/or an inter-IC sound (I²S) interface 164d, an inter-integrated circuit (I²C) bus interface 164e, and/or an audio interface 164f.

Aspects of the method and system may comprise a single chip that comprises a Bluetooth radio, an FM radio, a processor system, and a peripheral transfer unit (PTU). FM data may be received and/or transmitted via the FM radio and Bluetooth data may be received and/or transmitted via the Bluetooth radio. The FM radio may receive radio data system (RDS) data. The PTU may support a plurality of digital and analog interfaces that provides flexibility with the handling of data. A processor in the processor system may enable time-multiplexed processing of FM data and processing of Bluetooth data. The single chip may operate in an FM-only, a Bluetooth-only, and an FM-Bluetooth mode. The single chip may reduce power consumption by disabling portions of the Bluetooth radio during FM-only mode and/or disabling analog circuitry when performing digital processing. Communication between Bluetooth and FM channels may be enabled via the single chip.

FIG. 1B is a block diagram of an exemplary FM transmitter that communicates with handheld devices that utilize a single chip with integrated Bluetooth and FM radios, in accordance with an embodiment of the invention. Referring to FIG. 1B, there is shown an FM transmitter 102, a cellular phone 104a, a smart phone 104b, a computer 104c, and an exemplary FM and Bluetooth-equipped device 104d. The FM transmitter 102 may be implemented as part of a radio station or other broadcasting device, for example. Each of the cellular phone 104a, the smart phone 104b, the computer 104c, and the exemplary FM and Bluetooth-equipped device 104d may comprise a single chip 150 with integrated Bluetooth and FM radios for supporting FM and Bluetooth data communications. The FM transmitter 102 may enable communication of FM audio data to the devices shown in FIG. 1B by utilizing the single chip 150. Each of the devices in FIG. 1B may comprise and/or may be communicatively coupled to a listening device 108 such as a speaker, a headset, or an earphone, for example.

The cellular phone 104a may be enabled to receive an FM transmission signal from the FM transmitter 102. The user of the cellular phone 104a may then listen to the transmission via the listening device 108. The cellular phone 104a may comprise a “one-touch” programming feature that enables pulling up specifically desired broadcasts, like weather, sports, stock quotes, or news, for example. The smart phone 104b may be enabled to receive an FM transmission signal from the FM transmitter 102. The user of the smart phone 104b may then listen to the transmission via the listening device 108.

The computer 104c may be a desktop, laptop, notebook, tablet, and/or a PDA, for example. The computer 104c may be enabled to receive an FM transmission signal from the FM transmitter 102. The user of the computer 104c may then listen to the transmission via the listening device 108. The computer 104c may comprise software menus that configure listening options and enable quick access to favorite options, for example. In one embodiment of the invention, the computer 104c may utilize an atomic clock FM signal for precise timing applications, such as scientific applications, for example. While a cellular phone, a smart phone, computing devices, and other devices have been shown in FIG. 1B, the single chip 150 may be utilized in a plurality of other devices and/or systems that receive and use Bluetooth and/or FM signals. In one embodiment of the invention, the single chip Bluetooth and FM radio may be utilized in a system comprising a WLAN radio.

FIG. 1C is a block diagram of an exemplary FM receiver that communicates with handheld devices that utilize a single chip with integrated Bluetooth and FM radios, in accordance with an embodiment of the invention. Referring to FIG. 1C, there is shown an FM receiver 110, the cellular phone 104a, the smart phone 104b, the computer 104c, and the exemplary FM and Bluetooth-equipped device 104d. In this regard, the FM receiver 110 may comprise and/or may be communicatively coupled to a listening device 108. A device equipped with the Bluetooth and FM frequency converters, such as the single chip 150, may be able to broadcast its respective signal to a “deadband” of an FM receiver for use by the associated audio system. For example, a cellphone or a smart phone, such as the cellular phone 104a and the smart phone 104b, may transmit a telephone call for listening over the audio system of an automobile, via usage of a deadband area of the car's FM stereo system. One advantage may be the universal ability to use this feature with all automobiles equipped simply with an FM radio with few, if any, other external FM transmission devices or connections being required.

In another example, a computer, such as the computer 104c, may comprise an MP3 player or another digital music format player and may broadcast a signal to the deadband of an FM receiver in a home stereo system. The music on the computer may then be listened to on a standard FM receiver with few, if any, other external FM transmission devices or connections. While a cellular phone, a smart phone, and computing devices have been shown, a single chip that combines a Bluetooth and FM frequency converter and/or receiver may be utilized in a plurality of other devices and/or systems that receive and use an FM signal.

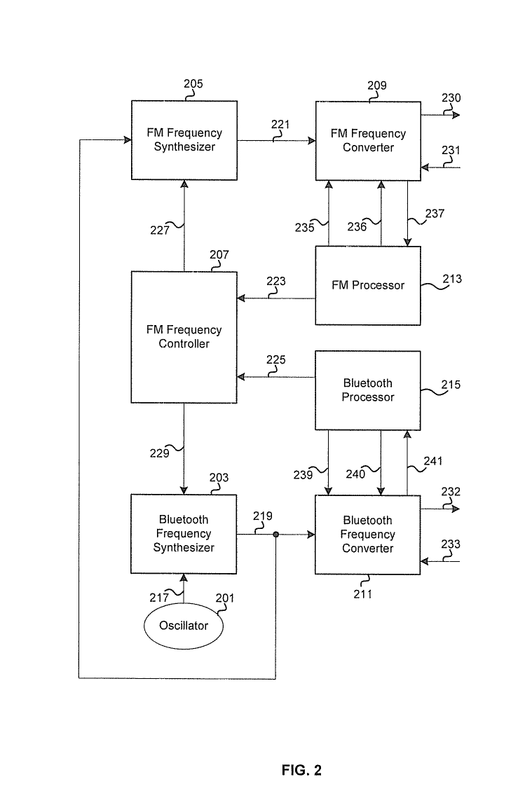

FIG. 2 is a block diagram of an exemplary system that supports Bluetooth and FM radio communication in accordance with an embodiment of the invention. The system comprises an oscillator 201, a Bluetooth frequency synthesizer 203, an FM frequency synthesizer 205, a frequency controller 207, an FM frequency converter 209, Bluetooth frequency converter 211, an FM processor 213, and a Bluetooth processor 215.

The oscillator 201 may be a temperature controlled crystal oscillator. The oscillator 201 may enable generation of a clock frequency 217 (e.g. 13 MHz, 26 MHz, 24.3 MHz), which may be utilized to drive the Bluetooth frequency synthesizer 203. The Bluetooth frequency synthesizer 203 may be a radio frequency generator that enables generation of a Bluetooth carrier frequency 219. In an exemplary embodiment of the invention, the Bluetooth carrier frequency 219 may be specified by the following relationship:

2.4 GHz+BT_{chan}_{_{—}}ₙᵤₘ×1 MHz,

where BT_{chan}_{_{—}}ₙᵤₘ is the channel number for the Bluetooth communication. It should noted that the IF may not be fixed or a direct conversion but it can be any frequency.

The Bluetooth frequency converter 211 may utilize the Bluetooth carrier frequency 219 to up-convert a received baseband Bluetooth transmit signal 240, thereby generating an output RF Bluetooth transmit signal 232. The Bluetooth frequency converter 211 may utilize the Bluetooth carrier frequency 219 to down-convert an RF Bluetooth received signal 233 thereby generating an output baseband Bluetooth receive signal 241. The Bluetooth processor 215 may generate a control signal 239 that enables time division multiplexing of transmission and reception by the Bluetooth frequency converter 211. The Bluetooth processor 215 may also enable sending of a BT_{chan}_{_{—}}ₙᵤₘ signal 225 to the frequency controller 207, which may be utilized to control operation of the Bluetooth frequency synthesizer 203. The frequency controller 207 may utilize the BT_{chan}_{_{—}}ₙᵤₘ signal 225 to control the Bluetooth frequency synthesizer 203 during adaptive frequency hopping (AFH).

The FM frequency synthesizer 205 may enable generation of an FM carrier frequency 221 based on the Bluetooth carrier frequency 219, the latter of which is generated by the Bluetooth frequency synthesizer 203. The FM carrier frequency 221 may be represented by the following relationship:

47.9+FM_{chan}_{_{—}}ₙᵤₘ×0.2 MHz,

where FM_{chan}_{_{—}}ₙᵤₘ is an integer channel designation from 201 to 300.

The FM frequency converter 209 may utilize the FM carrier frequency 221 may be used to up-convert an input baseband FM transmit signal 236, thereby generating an RF FM transmit signal 230. The FM frequency converter 209 may utilize the FM carrier frequency 221 to down-convert a received RF FM signal 231, thereby generating a baseband FM receive signal 237. The generated baseband FM receive signal 237 may be provided as input to the FM processor 213. The FM processor 213 may control via signal 235 time division multiplexing of transmission and reception by the FM frequency converter 209.

The FM frequency synthesizer 205 may enable generation of the FM carrier frequency 221 by dividing the Bluetooth carrier frequency 219 by a divisor 227 that may be supplied by the frequency controller 207. The divisor 227 is generated in the frequency controller 207 as the ratio of the Bluetooth carrier frequency 219 (2.4 GHz+BT_{chan}_{_{—}}ₙᵤₘ×1 MHz) to the FM carrier frequency 221 (47.9+FM_{RX}_{_{—}}_{chan}×0.2 MHz).

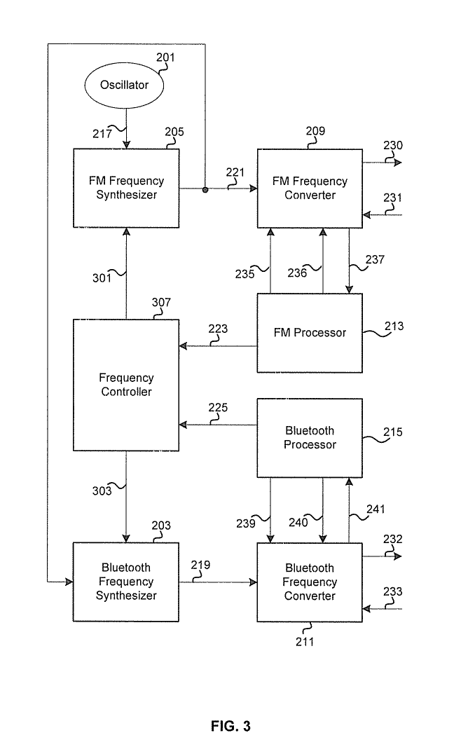

FIG. 3 is a block diagram of another exemplary system that supports Bluetooth and FM radio communication, in accordance with an embodiment of the invention. Referring to FIG. 3, there is shown an oscillator 201, a Bluetooth frequency synthesizer 203, a FM frequency synthesizer 205, a FM frequency converter 209, a Bluetooth frequency converter 211, a FM processor 213, a Bluetooth processor 215, and a frequency controller 307.

The oscillator 201 may be a temperature controlled crystal oscillator. The oscillator 201 may enable generation of a clock frequency 217 (e.g. 13 MHz, 26 MHz, 24.3 MHz) that may drive the FM frequency synthesizer 205. The Bluetooth frequency synthesizer 203 may comprise suitable logic, circuitry and/or code that may enable generation of a FM carrier frequency 221. The FM carrier frequency 221 may be represented by the following relationship:

47.9+FM_{chan}_{_{—}}ₙᵤₘ×0.2 MHz,

where FM_{chan}_{_{—}}ₙᵤₘ is an integer channel designation from 201 to 300.

The FM frequency converter 209 may utilize the generated FM carrier frequency 221 to up-convert a baseband FM transmit signal 236, thereby generating an output RF FM transmit signal 230. The FM frequency converter 209 may comprise suitable logic circuitry and/or code that may utilize the generated FM carrier frequency 221 to down-convert a received RF FM receive signal 231, thereby generating an output baseband FM signal 237. The generated output baseband FM signal 237 may be provided as an input to the FM processor 213. The FM processor 213 may comprise suitable logic, circuitry and/or code that may generate a control signal 235 that may enable time division multiplexing of transmission and reception by the FM frequency converter 209.

The Bluetooth frequency synthesizer 203 may comprise suitable logic, circuitry and/or code that may enable it to function as a radio frequency generator. The Bluetooth frequency synthesizer 203 may enable generation of a Bluetooth carrier frequency 219 based on the FM carrier frequency 221, the latter of which may be generated by the FM frequency synthesizer 205. In one exemplary embodiment of the invention, the Bluetooth carrier frequency 219 may be represented by the following relationship:

2.4 GHz+BT_{chan}_{_{—}}ₙᵤₘ×1 MHz,

where BT_{chan}_{_{—}}ₙᵤₘ may be the channel number for the Bluetooth channel utilized for Bluetooth communication. It should noted that the IF may not be fixed or a direct conversion but it can be any frequency.

The Bluetooth carrier frequency 219 generated by the Bluetooth frequency synthesizer 203 may be utilized by the Bluetooth frequency converter 211 to up-convert an input baseband Bluetooth transmit signal 240, thereby generating an output RF Bluetooth transmit signal 232. The input baseband Bluetooth transmit signal 240 may be generated by the Bluetooth processor 215. Bluetooth frequency converter 211 may comprise suitable logic circuitry and/or code that may enable down-conversion of a received signal. In this regard, the Bluetooth frequency converter 211 may utilize the Bluetooth carrier frequency 219 to down-convert a received RF Bluetooth signal 233, thereby generating an output baseband Bluetooth signal 241. The Bluetooth processor 215 may generate a control signal 239 that may enable time division multiplexing of transmission and reception by the Bluetooth frequency converter 211. The Bluetooth processor 215 may generate a BT_{chan}_{_{—}}ₙᵤₘ signal 225 that may be provided as an input to the frequency controller 307. The frequency controller 307 may utilize the BT_{chan}_{_{—}}ₙᵤₘ signal 225 to control the Bluetooth frequency synthesizer 203 during adaptive frequency hopping (AFH).

The Bluetooth frequency synthesizer 203 may comprise suitable logic, circuitry and/or code that may enable generation of the Bluetooth carrier frequency 219 by multiplying the FM carrier frequency 221 by a scalar 303 that is supplied by the frequency controller 307. The scalar 303 may be generated by the frequency controller 307 and may be represented as a ratio of the Bluetooth carrier frequency 219 (2.4 GHz+BT_{chan}_{_{—}}ₙᵤₘ×1 MHz) to the FM carrier frequency 221 (47.9+FM_{Rx}_{_{—}}_{chan}×0.2 MHz).

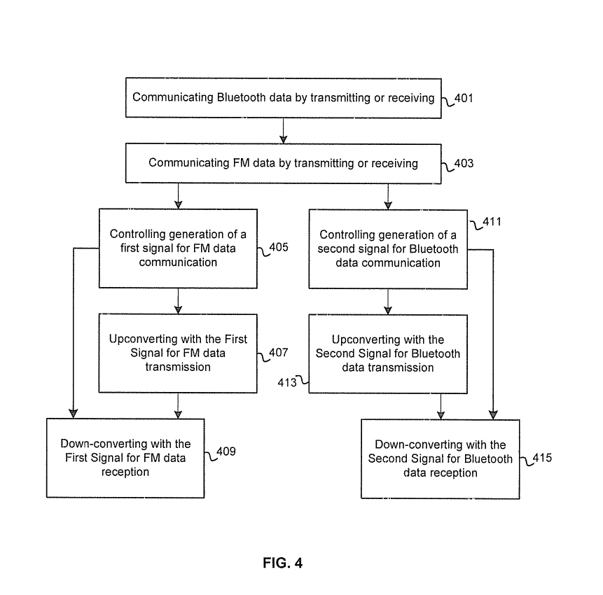

FIG. 4 is a flow diagram that illustrates exemplary steps for frequency conversion, in accordance with an embodiment of the invention. Referring to FIG. 4, in step 403, the communication of FM data may comprise transmission or reception of FM data. In step 405, generation of a first signal for FM data communication may be controlled. In this regard, the FM data may be modulated on an FM carrier frequency, which is generated for FM data communication. In step 407, for up-conversion, the FM carrier frequency may be utilized to modulate the FM data for transmition. In step 409, for down-conversion, the FM carrier frequency may be removed from the FM data during demodulation.

In step 401, the communication of Bluetooth data may comprise transmission and/or reception of Bluetooth data. In step 411, the generation of a second signal for Bluetooth data communication may be controlled. In this regard, the Bluetooth data may be modulated by a Bluetooth carrier frequency, which is generated for Bluetooth data communication 411. In step 413, for up-conversion, the Bluetooth carrier frequency may be applied to the Bluetooth data for transmission. In step 415, for down-conversion, the Bluetooth carrier frequency may be removed from the Bluetooth data during demodulation.

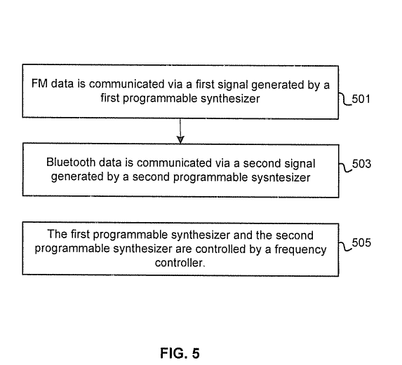

FIG. 5 is a flow diagram that illustrates an exemplary method for frequency conversion in accordance with an embodiment of the invention. FM data may be communicated via a first signal generated by a first programmable synthesizer in step 501. This FM data is time multiplexed between receiving FM data and transmitting FM data.

Bluetooth data is communicated via a second signal generated by a second programmable synthesizer in step 503. This Bluetooth data is time multiplexed between receiving Bluetooth data and transmitting Bluetooth data. The second signal may change frequency according to an adaptive frequency-hopping (AFH) map for said communicated Bluetooth data.

The first and second programmable synthesizers may be configured in two ways. The signal from the first programmable synthesizer from step 501 may be based on a received oscillator signal, and the signal from the second programmable synthesizer from step 503 may be based on the signal from the first programmable synthesizer. Alternatively, the signal from the second programmable synthesizer may be based on a received oscillator signal, and the signal from the first programmable synthesizer may be based on the signal from the second programmable synthesizer.

The first and second programmable synthesizers are controlled via a frequency controller in 505. The first and second programmable synthesizers are communicatively coupled to an FM processor that enable said communicating of said FM data and a Bluetooth processor that enables said communication of said Bluetooth data.

In accordance with an embodiment of the invention, with reference to FIG. 3, a system for supporting wireless communication may comprise a first programmable synthesizer 205 that enables generation of a first signal 221 for communication of FM data. A second programmable synthesizer 203 may be utilized to enable generation of a second signal 219 for communicating Bluetooth data. A single frequency controller 307 may be utilized to enable control of the first programmable synthesizer 205 and the second programmable synthesizer 203. The single frequency controller 307 may be communicatively coupled to an FM processor 213 that enables the communicating of the FM data and to a Bluetooth processor 215 that enables the communicating of the Bluetooth data.

The FM processor 213 may enable time multiplexing between receiving of the FM data and transmitting of the FM data. The Bluetooth processor 215 may also enable time multiplexing between receiving of the Bluetooth data and transmitting of the Bluetooth data. The second signal 219 may change frequency according to an adaptive frequency hopping (AFH) map for the communicated Bluetooth data. The first programmable synthesizer 205 may enable generation of the first signal 221 based on a received oscillator signal 217 generated by an oscillator 201. The second programmable synthesizer 203 may enable generation of the second signal 219 based on the generated first signal 221. The second programmable synthesizer 203 may enable generation of the second signal 219 based on the received oscillator signal 217 generated by the oscillator 201. The first programmable synthesizer 205 may also enable generation of the first signal 221 based on the generated second signal 219.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for supporting wireless communication, the method comprising:
communicating FM data via a first signal generated by a first programmable synthesizer;
communicating Bluetooth data via a second signal generated by a second programmable synthesizer; and
controlling said first programmable synthesizer and said second programmable synthesizer via a single frequency controller communicatively coupled to an FM processor that enables said communicating of said FM data and to a Bluetooth processor that enables said communicating of said Bluetooth data.

2. The method according to claim 1, wherein said communicating FM data further comprises time multiplexing between receiving said FM data and transmitting said FM data.

3. The method according to claim 1, wherein said communicating Bluetooth data further comprises time multiplexing between receiving of said Bluetooth data and transmitting of said Bluetooth data by said Bluetooth processor.

4. The method according to claim 1, wherein the second signal changes frequency according to an adaptive frequency hopping (AFH) map for said communicated Bluetooth data.

5. The method according to claim 1, further comprising generating said first signal by said first programmable synthesizer based on a received oscillator signal.

6. The method according to claim 5, further comprising generating said second signal by said second programmable synthesizer based on said generated first signal.

7. The method according to claim 1, further comprising generating said second signal by said second programmable synthesizer based on a received oscillator signal.

8. The method according to claim 7, further comprising generating said first signal by said first programmable synthesizer based on said generated second signal.

9. A system for supporting wireless communication, the system comprising:
a first programmable synthesizer that enables generation of a first signal for communication of FM data;
a second programmable synthesizer that enables generation of a second signal for communicating Bluetooth data; and
a single frequency controller the enables controlling of said first programmable synthesizer and said second programmable synthesizer, wherein said single frequency controller is communicatively coupled to an FM processor that enables said communicating of said FM data and to a Bluetooth processor that enables said communicating of said Bluetooth data.

10. The system according to claim 9, wherein said FM processor enables time multiplexing between receiving said FM data and transmitting said FM data.

11. The system according to claim 9, wherein said Bluetooth processor enables time multiplexing between receiving of said Bluetooth data and transmitting of said Bluetooth data.

12. The system according to claim 9, wherein the second signal changes frequency according to an adaptive frequency hopping (AFH) map for said communicated Bluetooth data.

13. The system according to claim 9, wherein said first programmable synthesizer generates said first signal based on a received oscillator signal.

14. The system according to claim 13, wherein said second programmable synthesizer generates said second signal based on said generated first signal.

15. The system according to claim 9, wherein said second programmable synthesizer generates said second signal based on a received oscillator signal.

16. The system according to claim 15, wherein said first programmable synthesizer generates said first signal based on said generated second signal.

17. A system for supporting wireless communication, the system comprising:
an FM frequency synthesizer;
an FM frequency converter, communicatively coupled to said FM frequency synthesizer, for receiving FM signals;
an FM processor for processing said received FM signals;
a Bluetooth frequency synthesizer;
a Bluetooth frequency converter, communicatively coupled to said Bluetooth frequency synthesizer, for transmitting and receiving Bluetooth signals;
a Bluetooth processor for processing Bluetooth signals; and
a frequency controller, communicatively coupled to said FM processor and to said Bluetooth processor, for controlling said FM frequency synthesizer and said Bluetooth frequency synthesizer.

18. The system according to claim 17, wherein said FM frequency converter is further capable of transmitting FM signals.

19. The system according to claim 18, wherein said FM processor is capable of controlling said FM frequency converter for time multiplexing between receiving FM signals and transmitting FM signals.

20. The system according to claim 17, wherein said Bluetooth processor is capable of controlling said Bluetooth frequency converter for time multiplexing between receiving Bluetooth signals and transmitting Bluetooth signals.

21. The system according to claim 17, wherein said frequency controller changes a carrier frequency output of said Bluetooth frequency synthesizer according to an adaptive frequency hopping (AFH) map.

22. The system according to claim 17, wherein said Bluetooth frequency synthesizer receives an oscillator signal to generate a Bluetooth carrier frequency.

23. The system according to claim 22, wherein said FM frequency synthesizer receives said Bluetooth carrier frequency to generate an FM carrier frequency.

24. The system according to claim 17, wherein said FM frequency synthesizer receives an oscillator signal to generate an FM carrier frequency.

25. The system according to claim 24, wherein said Bluetooth frequency synthesizer receives said FM carrier frequency to generate a Bluetooth carrier frequency.
